(19) United States
(12) Patent Application Publication
(10) Pub. No.: US 2012/0265702 A1
(43) Pub. Date: Oct. 18, 2012

(54) System And Method For Storing And Presenting Animal Certification Information

(75) Inventor: Kevin D. Maher, Ames, IA (US)

(73) Assignee: GlobalVetLINK,LC

(21) Appl. No.: 13/446,865

(22) Filed: Apr. 13, 2012

Related U.S. Application Data
(60) Provisional application No. 61/475,041, filed on Apr. 13, 2011.

(51) Int. Cl. G06Q 10/00

(52) U.S. Cl. 705/317

(57) ABSTRACT

Systems and methods issue a certificate for an animal. A request to generate the certificate is received and required information for the certificate is determined based upon rules and regulations, stored within a database, that define information requirements for the certificate. The method interacts with one or more of an owner of the animal, a certified veterinarian, and a laboratory to collect the required information. The certificate is generated with a unique identifier when the required information is complete, and the certificate is stored within the database.

### RELATED APPLICATIONS

This application claims priority to U.S. Patent Application Ser. No. 61/475,041, filed Apr. 13, 2011, which is incorporated herein by reference.

### BACKGROUND

Animal health certificates are required to move animals such as livestock, pets, and show animals, across state lines within the United States of America. These certificates are a hand-completed 4-part carbon form that includes information of the animal being moved, including necessary test results performed on the animal for the required movement. The owner must produce a certificate for each animal being moved when transporting animals across state lines, for example. The time to obtain a certificate usually takes one to three days and in most cases the obtained certificate is valid for up to one month.

To obtain an Equine Infectious Anemia or ‘Coggins’ certificate for a particular animal, an owner brings the animal to a veterinarian or the veterinarian goes to the location of the animal, where blood is drawn from the animal. Information of the owner and the animal, including three sketches of the animal showing its distinguishing features, are added to the forms. For example, for a horse, sketches are made of each side view of the animal; and a frontal head view, wherein distinguishing features, such as patterns in the coat, are included in the sketch. Information of the veterinarian, a laboratory that will perform tests on the blood, and associated addresses, are added to the forms, and the blood and forms are sent (e.g., using a postal or delivery service) to the laboratory.

Upon receiving the blood and form, the laboratory performs required tests on the blood, adds the results of these tests to the form, which when complete with the veterinarian and laboratory information forms the certificate. The laboratory keeps and files one part of the form, one part goes to the state animal health official, and the remaining parts of the form are sent back to the veterinarian. The veterinarian keeps and files one part of the form, and sends one part to the owner.

These hand completed certificates and the labor intensive process for generating them is subject to errors, missing data, and misplacement. For example, if the owner loses a certificate when in transit, the owner must request a new copy of the form from the veterinarian or the laboratory, and wait for that copy to be sent (e.g., faxed or mailed) to them.

### SUMMARY

In one embodiment, a computer-implemented system is used for animal certification. The system includes a database for storing rules and regulations that define requirements for the animal certification, a web interface for receiving a request for a certificate for an animal, a requirement interpreter for generating a procedure for acquiring information required to complete the certificate based upon the rules and regulations and a type of the certificate, a certificate engine for collecting information for the certificate based upon the procedure, and a certificate producer for generating the certificate based upon the collected information and for storing the certificate within the database.

In another embodiment, a computer implemented method issues a certificate for an animal. A request to generate the certificate is received and required information for the certificate is determined based upon rules and regulations, stored within a database, that define information requirements for the certificate. The method interacts with one or more of an owner of the animal, a certified veterinarian, and a laboratory to collect the required information. The certificate is generated with a unique identifier when the required information is complete, and the certificate is stored within the database.

In another embodiment, a device determines validity of a certificate for an animal. The device includes a network interface for communicating with a certification system, a user interface for interacting with a user of the device, and an application running on the device. The application has machine readable instructions that when executed by a processor of the device (a) determines identification information associated with the certificate, (b) sends the identification information to the certification system, (c) receives, from the certification system, an indication of validity of the certificate, and (d) displays the indication on the user interface.

In another embodiment, a computer-implemented system provides animal certification. The system includes a database that stores rules and regulations that define requirements for the animal certification, a web interface for receiving a request for a certificate for an animal, a certificate engine for collecting information required to complete the certificate based upon the rules and regulations and a type of the certificate, an information validator for validating the collected information against the rules and regulations to determine whether the collected information is sufficient to complete the certificate and is valid, and a certificate producer for generating the certificate based upon the collected information and for storing the certificate within the database

### BRIEF DESCRIPTION OF THE FIGURES

FIG. 1 shows one exemplary system for storing and presenting animal certification information, in an embodiment.

FIG. 2 shows exemplary detail of the system of FIG. 1, in an embodiment.

FIG. 3 is a flowchart illustrating one exemplary method 300 for storing and presenting animal certification information, in an embodiment.

FIG. 4 is a flowchart illustrating one exemplary method for the step of collecting information of the method of FIG. 3, in an embodiment.

FIG. 5 is a schematic diagram illustrating exemplary use of the system of FIG. 1 to verify authenticity of a presented certificate for an animal passing through a control point, in an embodiment.

FIG. 6 is a flowchart illustrating one exemplary method for validating an identified certificate within the system of FIG. 1.

FIG. 7 is a schematic showing exemplary detail of the certificate of FIG. 1.

FIG. 8 is an image of one exemplary certificate produced by the system of FIG. 1 and printed by the owner using printer.

FIG. 9 shows one exemplary laboratory submittal form with a machine readable code that facilitates tracking of a blood sample, sent by a veterinarian to a laboratory, within the system of FIGS. 1 and 2, in an embodiment.

FIG. 10 shows one exemplary veterinary inspection certificate that is generated by the system of FIGS. 1 and 2 to indicate inspection of the animal by the certified veterinarian, in an embodiment.

FIG. 11 shows one exemplary prescription certificate for use of medication within animal feed, as tracked by the system of FIGS. 1 and 2, in an embodiment.

FIG. 12 shows one exemplary certificate generated by the system of FIGS. 1 and 2 as required to move a horse between states, in an embodiment.

FIG. 13 shows one exemplary method for generating a procedure for collecting required information for the certificate of FIGS. 1 and 2, in an embodiment.

### DETAILED DESCRIPTION OF THE EMBODIMENTS

The present disclosure may be understood by reference to the following detailed description taken in conjunction with the drawings as described below. For purposes of illustrative clarity, certain elements in the drawings are not drawn to scale. In the following description, animal movement examples are used as animal movement between states of the USA requires certification; however, the systems and methods described herein may be applied to all known and future animal health certification requirements.

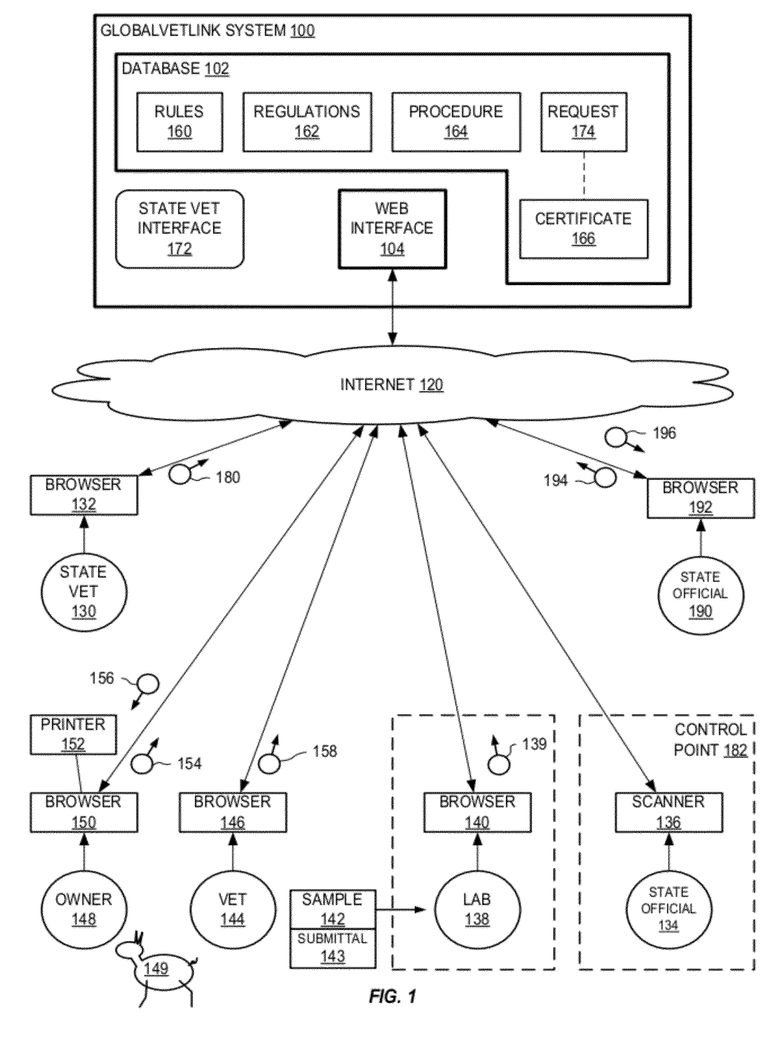

FIG. 1 shows one exemplary system 100 for storing and presenting animal certification information. System 100 is shown with a database 102 and a web interface 104 that connects to Internet 120. Internet 120 represents the World Wide Web for example. System 100 is for example constructed of one or more servers that support and control access to database 102 via web interface 104. Database 102 is for example a relational database implemented using a mass data storage device (e.g., a network storage device).

Web interface 104 provides a secure access portal to system 100, via Internet 120, for a state veterinarian 130, a state officials 134 and 190, a laboratory 138, an accredited veterinarian 144, and an animal owner 148. For example, web interface 104 may include one or more web addresses (URLs) that allow access to system 100 from web browsers and/or other Internet connected devices. Functionality of system 100 is for example implemented as “software as a service” (SaaS), known in the art. State veterinarian 130, state official 190, laboratory 138, accredited veterinarian 144, and owner 148 utilize browsers 132, 140, 146, 150, and 192, respectively, to access services of system 100 via Internet 120 and web interface 104. Each browser 132, 140, 146, 150, and 192 may operate on one of a personal computer, a smart phone, a personal digital assistant, television, and other Internet and network enabled devices.

System 100 supports certification of all types of animal, including avian, bovine, canine, caprine, cervid, equine, feline, ovine, poultry, swine, zoological, aquatic, and other species. System 100 receives and stores (e.g., within database 102) many forms of animal identification that are entered into system 100 by accredited veterinarians including: visual tags, electronic identification devices, digital photographs, iris or retina identifying properties, DNA profile, premises identification, and more. For example, data may be entered by accredited veterinarian 144, using browser 146, into system 100 from a spreadsheet and/or a text file. In the following examples, certain types of certificate are shown; however, system 100 may operate with many additional types of certificate without departing from the scope hereof. In one embodiment, accession numbers are generated by laboratory 138 (e.g., using a manual process or are generated using an internal laboratory information management system that may, or may not, be integrated into the system), and then applied to certificate 166. In one embodiment, system 100 includes a laboratory integration option that allows laboratory 138 to electronically apply accession numbers and results 139 to certificate 166, including a date the sample was received, a date that the results were reported, a name of a technician performing the tests, and a signature of the technician.

State veterinarian 130 maintains state rules and state regulations within system 100 that define requirements for moving animals into and within their respective state, for example. In one example of operation, state veterinarian 130 uses browser 132 to update rules 160 and regulations 162 within database 102 of system 100. Rules 160 and regulations 162 define requirements for certification of animal movement within states and between states, and may be updated electronically in real-time as disease and health conditions change. In one example of operation, state veterinarian 130 prepares an update file 180 that defines additions, amendments, and/or cancellations to rules and regulations for animal movement into and within their state. In another example of operation, a livestock event venue official prepares update file 180 that defines additions, amendments, and/or cancellations to rules and regulations for animal movement into and within their event venue. File 180 is uploaded to system 100 via browser 132, Internet 120 and web interface 104, and processed by a state veterinarian interface 172 within system 100 that updates rules 160 and regulations 162 within database 102 based upon file 180. Each state within the United States of America has at least one state animal health official (e.g., a state veterinarian 130 or lay person appointed by the state) for example who is authorized to update these rules and regulations within system 100. Also, livestock event officials may be appointed as state animal health official upon approval of state veterinarian 130, for example.

In one embodiment, rules 160 define which certificates are required for a particular state, and regulations 162 define which information is required for those certificates within that state. For example, to move a horse from a first to a second state, rules 160 define that, for the second state, a valid Equine Infectious Anemia certificate is required for the horse before it will be allowed to enter the second state. Regulations 162 define that, for the second state, the Equine Infectious Anemia certificate requires a blood test to have been performed by an accredited laboratory within a predefined period prior to the intended movement of the animal, and that the test results are negative. Regulations 162 may also specify that the certificate identify the animal and its location within the first state, that the certificate lists the veterinarian that drew the blood sample from the animal and lists the laboratory used to test the sample. Regulations 162 may also specify that the information be digitally signed by the owner, the veterinarian, and the laboratory to attest to its validity. System 100 facilitates compliance to the appropriate rules and regulations by owner 148 when moving an animal 149 from a starting location to a destination. In another example, rules 160 and regulations 162 may define that an animal moving from a first state to a second state has a valid certificate indicating that it has been examined and/or has had certain inoculations.

To move animal 149, owner 148 contacts veterinarian 144 to request a certificate for moving animal 149 from a start location (e.g., the owner's stables) to a destination (e.g., a stock show in a neighboring state). In one example, owner 148 sends a message 154, using browser 150, to system 100 requesting a certificate for moving animal 149. System 100 stores a request 174 within database 102 and notifies veterinarian 144 that owner 148 has requested the certificate for animal 149. In another example, owner 148 contacts local accredited veterinarian 144 directly to request the certificate for animal 149, wherein veterinarian 144 interacts with system 100 to create request 174.

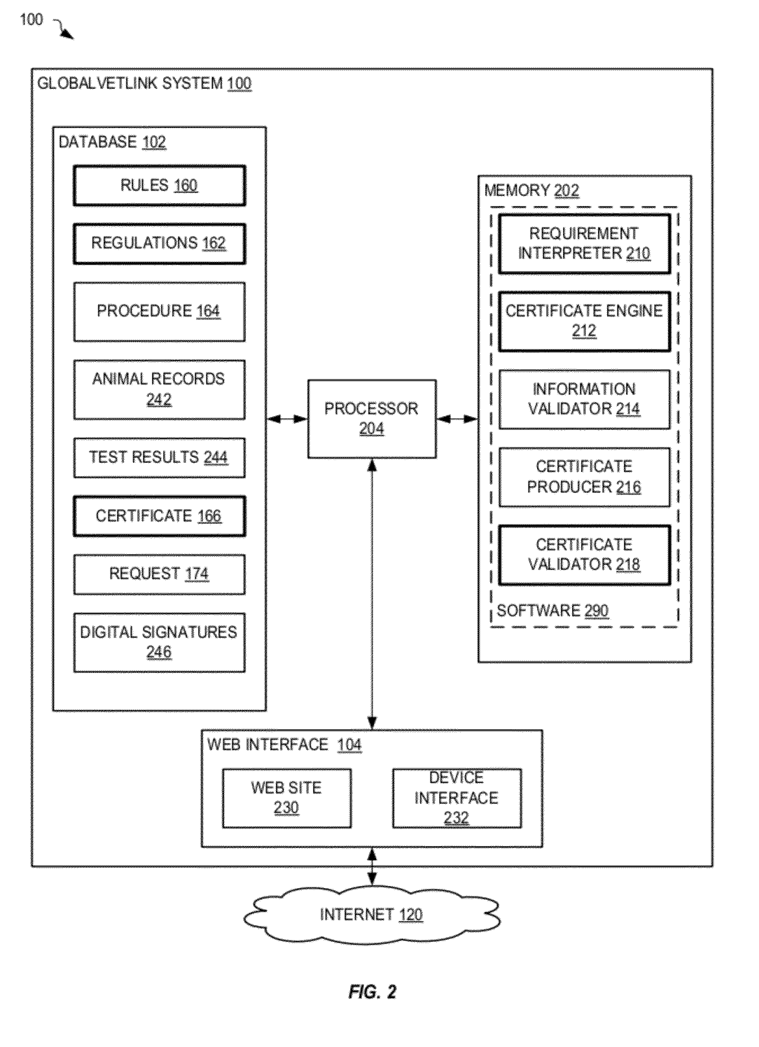

Certification for moving animals requires an accredited veterinarian (e.g., veterinarian 144) to certify that the certificate correctly identifies the animal to be moved, and that blood samples were taken from that animal and sent for testing at an accredited laboratory (e.g., laboratory 138), and/or that vaccinations were administered to the animals according to entry requirements. The laboratory verifies that test results are derived from the sample sent by the veterinarian. Vaccinations or similar requirements may be entered into system 100 by veterinarian 144. Each owner, veterinarian, and laboratory that uses system 100 has a unique digital signature (eSignature) stored within system 100 (e.g., within database 102, see digital signatures 246 of FIG. 2) that is accessed using a login username and password of the owner, veterinarian, and laboratory, respectively. When information is entered into system 100, the party entering the information applies their digital signature to indicate that the supplied information is correct. Certificates may be validated by verifying that the digital signature applied to a certificate is authentic and that it is appropriate for its use on the certificate. The certificate itself may be validated within system 100. For example, within system 100, a digital certificate process runs in the background as part of a comprehensive security measure to further ensure security of the document.

Request 174 identifies owner 148, veterinarian 144 and at least a type of animal 149, together with the start location and the destination of the requested movement for animal 149. System 100 determines an appropriate certificate 166 for the requested movement of animal 149 based upon rules 160 and regulations 162 of the state or states involved in the movement. Typically, certification is required only for the destination state. However, state requirements may vary, for example in the case of a national disease emergency, each state through which the animal is to pass may require a certificate and/or have additional entry requirements. System 100 determines the requirements for each transited state and generates required certificates automatically. For example, where animal 149 is to pass through one or more intermediate states when moving from the start location to the destination, system 100 determines, based upon rules 160 and regulations 162 for each states, certification requirements and generates required certificates.

Veterinarian 144 interacts with system 100 via browser 146, Internet 120, and web interface 104, to enter information associated with request 174 and certificate 166. For example, veterinarian 144 may enter contact information for himself and of owner 148, details of the requested movement of animal 149, and identification information of animal 149. In one example, where animal 149 is a horse, veterinarian 144 may capture digital images showing distinguishing marking of animal 149, and send these images to system 100 where they are stored in association with request 174 and certificate 166. Other types of animals may be identified by other means, such as visual tags, RFID tags, DNA profile, Iris or Retina attributes, and so on. Veterinarian 144 may take a sample 142 (e.g., draw blood) from animal 149 and send sample 142 to laboratory 138 for testing based upon testing requirements of certificate 166.

System 100 may store information of owner 148, veterinarian 144, and animal 149 within database 102 for future reference such that veterinarian 144 and/or owner 148 need not enter the same information each time a certificate is requested for movement of animal 149. In one example of operation, owner 148 and/or veterinarian 144 select the information from one or more lists displayed by system 100. In another example of operation, system 100 determines the information from database 102 based upon identification of animal 149.

Upon receiving sample 142, laboratory 138 performs test specified by veterinarian 144 and/or system 100, and uploads test results 139 to system 100 via browser 140, Internet 120, and web interface 104. Sample 142 may include identification information that identified one or both of request 174 and certificate 166 within database 102, wherein laboratory 138 identifies the request or certificate within test results 139.

System 100 attaches digital signatures from laboratory 138 (e.g., upon authority of a technician at laboratory 138) and veterinarian 144 to certificate 166 as proof that certificate 166 conforms to required practice. Once all required portions of certificate 166 are complete, system 100 produces certificate 166 for use by owner 148. In one example, system 100 notifies veterinarian 144 that certificate 166 is complete and ready for use by owner 148, wherein veterinarian 144 may then notify owner 148. In another example, system 100 notifies both veterinarian 144 and owner 148 that certificate 166 is complete and ready for use, wherein owner 148 then prints certificate 166 on a local printer 152 connected to browser 150. Access to certificate 166 by owner 148 may be at the discretion of veterinarian 144, occurring via barcode/QR code scanning (or similar image) as well as other electronic media retrieval.

In one embodiment, system 100 provides a communication mechanism that allows communication (e.g., message passing, VoIP communication) between laboratory 138, veterinarian 144 and owner 148. For example, owner 148 and/or veterinarian 144 may submit Equine Infectious Anemia (EIA) analysis (and/or other required tests) requests and receive results in near real-time.

Specifically, system 100 includes one or more applications that facilitate submission of data by owner 148, veterinarian 144, and laboratory 138.

Exemplary certification supported by system 100 includes Official Certificates of Veterinary Inspection (OCVI), Online EIA (Coggins Certificates), and Electronic Veterinary Prescription Certificate System (eVRx®), For Sale Certificate (Pre-Purchase Exam), Pre-Conditioning Certificate, Vaccination Certificates, Insurance or Related Exam Certificate, and other Lab Test Certificates. An OCVI certificate is used by accredited veterinarians to efficiently document animal health status to meet official interstate movement requirements. Coggins certificates provide Equine Infectious Anemia certification utilizing digital photos and digital signatures (eSignatures) and integrate diagnostic laboratory data with information provided by accredited veterinarians based upon requirements by state/provincial/federal animal health officials. As described below, digital signatures are maintained within database 102 and provide a secure, traceable, and verifiable means for authenticating certificates. The Coggins certificates are approved by USDA-APHIS-VS to support documentation for international movement of horses. System 100 allows veterinarians to create, update, and standardize all client prescriptions (eVRx® certificates), along with documentation of a current veterinary-client-patient-relationship. The veterinarian may manage multiple production site prescriptions, or other client's animal prescriptions, quickly renew prescriptions prior to expiration, create and manage multiple prescriptions within system 100, and conform to the North American Compendium for current swine (and other species) product labeling.

In one example of operation, browser 146 operates on a portable Internet connected device (e.g., a smart phone or tablet) to allow veterinarian 144 to access system 100 when visiting animal 149 at the stable or location of owner 148. Mobile device access to system 100 allows veterinarian 144 to create prescription certificates (e.g., eVRx®), administer injections, and document these administrations, as required by state and/or Federal regulations, such as for animals used for food products. System 100 records such documentation within database 102, thereby allowing veterinarian 144 to retrieve this documentation later. System 100 thereby simplifies veterinary practice by allowing veterinarian 144, while traveling to visit animals, to prescribe, administer, and document medications given to animals. System 100 may also provide reminders and/or other prompts to each handling veterinarian for prescriptions that are to be repeated. Even when prescriptions have expired, associated information remains stored within database 102 for future reference, thereby allowing owners, veterinarians, drug producers, DVMs, and distributors to track the use of specific drugs through access to system 100. For example, system 100 may provide statistical data to drug manufacturers showing demographics of where their product is used. Further, product use is fully traceable within system 100 allowing owners and drug manufacturers and food industry customers to identify animals that have used a specific drug. In one embodiment, system 100 provides details such as: farm name, address (e.g., a premises number and/or emergency address), animals treated (e.g., a total number of animals, animals listed by a group and/or a lot number, or listed by individual animal identity, phase of production, etc., product (drug) name, dosage instructions, route of administration, withdrawal notice, special instructions, GPS location, and may order visits and treatments by heard health status.

Certain state regulations require that examination certificates are provided by vendors of certain animals, such as cats and dogs in the state of Florida for example. Within these states, tests, vaccines, and anthelmintics must be administered according to state and/or local requirements, and a certificate obtained before the animal is offered for sale, unless a licensed, accredited veterinarian certifies that the application is not in the best medical interest of the animal on an official certificate of veterinary inspection (OCVI) for the animal. System 100 facilitates compliance to state and local requirements and provides rapid and verifiable certification. For example, system 100 facilitates vendor and veterinarian compliance to Statute 828.29 within the state of Florida.

In another example, for Iowa, system 100 implements a preconditioned calf certification system, wherein certain calf labeling (e.g., Preconditioned, Green Tag, and Gold Tag) is based upon inspection by a licensed veterinarian and verification that all required treatments, vaccinations and program requirements have been performed before a calf may be so labeled. This system provides a validated, third-party method of animal health certification and qualification for the Green and Gold Tag programs, and thus provides more confidence of health by purchasers.

System 100 supports GoPass® which is a 6 month equine movement passport certificate. System 100 provides a fast alternative to the conventional 30 day paper based certificate procedure for moving horses for up to six months within the US. The GoPass uniquely validates animal qualification into the appropriate GoPass region, by logic maintained within system 100. A movement itinerary is also part of the system, which the animal owner may access, and report to state animal health officials of real-time animal movements within the approved GoPass region.

System 100 also facilitates issue, by veterinarian 144, of prescription certificates for feed grade antibiotic use in swine rations, wherein system 100 stores associated data (e.g., feed mills) within database 102 and provides prescription reporting and verification. System 100 meets FDA requirements for electronic transmission of data and documents, as well as it meets FDA eSingature statute: 21CFR Part 11, and follows guidance 120 associated therewith. Guidance 120 is defined within FDA document: http://www.fda.gov/downloads/AnimalVeterinary/GuidanceComplianceEnforcement/GuidanceforIndustry/UCM052660.pdf. Further technical requirements for digital signature (eSignature) acceptance by the FDA and required by Guidance 120 may be found at http://www.fda.gov/RegulatoryInformation/Guidances/ucm125067.htm.

In one embodiment, system 100 implements an owner web site (e.g., www.MyVetLink.com) that allows owner 148 read-only access to electronic health documents, via username and password, that are provided online by veterinarian 144 and laboratory 138. For example, test results that are part of animal movement certification may be accessed by owner 148. Where veterinarian 144 and/or laboratory 138 has performed other test on animals of owner 148, owner 148 may view data on these test and/or test results using browser 150 to access system 100. This access avoids delays for data access by owners, promotes validated and approved animal movements, and improves the level of service provided to veterinary clients. System 100 may include other authorized web sites and/or portals to other systems (e.g., partners of system 100) to provide additional information and services to one or more of owner 148, veterinarian 144 and laboratory 138.

### Official Access to Stored Information

System 100 allows state official 134 (e.g., animal health officials from all 50 states of the US) to generate, in real-time, reports for certain data stored within database 102, and particularly relating to certificates 166. For example, state official 134 may query system 100 and generate a report for one or more of regulatory animal imports, exports, intrastate movements, as well as laboratory testing. Additional reporting attributes include: animal identifiers (multiple), owner name and location, veterinarian, premises, species, species category, purpose of movement, destination, tests, vaccinations, and data export for integration into other systems. International certificate and connectivity may occur with the system, supporting languages and units of measure, meeting the country of import's movement requirements. System 100 allows integration partners to incorporate functionality into their system to allow their licensed users to access certain information stored within system 100 and to generate Health Documents. Appropriate documentation is provided on system 100 to facilitate interfacing with partner systems upon request, however partner systems would be responsible for making detailed reports available to their licensees.

### Reference Information

In one embodiment, system 100 provides additional information relating to animal testing and regulations. For example, prior to initiating veterinary test and procedure, owner 148 may access system 100 to determine regulations and requirements for moving animal 149 from the start location to the destination. In another example, system 100 provides a searchable directory of aquaculture laboratories that allows searching based upon tests that are available by state, laboratory, type of aquaculture, and so on.

FIG. 2 shows exemplary detail of system 100 of FIG. 1. System 100 is shown with database 102, web interface 104, a memory 202 and a processor 204. Memory 202 may represent one or more of a hard drive, volatile memory, non-volatile memory, network storage, and so on, and is shows storing software 290 of system 100. In one embodiment, database 102 is stored within memory 202. In another embodiment, database 102 is stored within one or more network storage devices that are couples with processor 204. Processor 204 may represent one or more processors and/or processor cores that execute instructions of software 290 to implement functionality of system 100. Web interface 104 is also implemented, at least in part, by software (not shown) stored within memory 202. In one embodiment, web interface 104 is implemented on a separate server that couples and cooperates with processor 204.

Software 290 includes a requirement interpreter 210, a certificate engine 212, an information validator 214, a certificate producer 216, and a certificate validator 218. Requirement interpreter 210 is an algorithm that processes rules 160 and regulations 162 to generate procedures 164 that define steps required for obtaining a certificate for movement of an animal based upon request 174. In one example of operation, requirement interpreter 210 is invoked by web interface 104 when owner 148 and/or veterinarian 144 creates request 174, to generate procedure 164 that defines the necessary steps for obtaining information required to generate certificate 166 based upon state requirements.

Certificate engine 212 is an algorithm that interprets procedure 164 and interacts, via web interface 104, with one or more of owner 148, veterinarian 144 and laboratory 138 to collect information required to complete certificate 166 that will allow owner 148 to move animal 149. For example, certificate engine 212 interacts (e.g., using web interface 104) with owner 148 and/or veterinarian 144 to collect information including information of owner 148, veterinarian 144, the species of animal 149, and the desired purpose of movement, wherein a digital signature is provided by the owner and/or veterinarian to provide authenticity of the information. System 100 stores digital signatures 246 within database 102, and applies selected and authorized ones of these digital signatures to certificate 166. For example, owner 148 enters a username and password to apply his/her digital signature to certificate 166 once they have verified that information within certificate 166 is correct. Similarly, veterinarian 144 and a technician of laboratory 138 apply their respective digital signature from digital signatures 246 using their respective username and password. Based upon the requested certificate, certificate engine 212 may instruct veterinarian 144 to collect a blood sample 142 from animal 149 for testing by laboratory 138 and then certificate engine 212 interacts with laboratory 138 to collect and store, within database 102, test results 244 from testing of sample 142. Laboratory 138 applies their digital signature to verify the authenticity of uploaded results. Information validator 214 is an algorithm that is invoked by certificate engine 212 to determine whether the necessary information has been collected to complete certificate 166, and whether the information includes the necessary digital signatures that prove authenticity of that information. System 100 may determine additional requirements prior to movement of an animal, such as other tests, vaccinations, certification statements, isolation statements, and other conditions.

Where multiple certificates are required for the movement of animal 149, certificate engine 212 automatically ensures the information for each certificate is complete, requesting additional information as necessary from one or more of owner 148, veterinarian 144 and laboratory 138. For example, different states may have different rules 160 and regulations 162 for movement of animal 149, wherein certificate engine 212 generates at least one certificate 166 to comply with the rules and regulations of the destination state, and if required, of each state involved in the movement of the animal. Where information is provided by a plurality of difference sources, e.g., owner 148, veterinarian 144, and laboratory 138, certificate engine 212 correlates received information and determine when procedure 164 is complete and certificate 166 may be produced.

Certificate producer 216 is an algorithm for generating certificate 166 based upon collected information. Certificate 166 may be provided in one or more formats, based upon request 174. In one embodiment, certificate producer 216 generates certificate 166 as a file in Adobe PDF format and sends the file to one or both of owner 148 and veterinarian 144. In another embodiment, certificate producer 216 generates certificate 166 in HTML format for displaying on a web page generated by web interface 104, for example. Certificate producer 216 may be configured to generate a representation of certificate 166 in any format requested by owner 148, veterinarian 144 and state officials 134, 190.

In one embodiment, requirement interpreter 210, certificate engine 212, information validator 214, and certificate producer 216 form part of a single software entity for automatically interpreting rules 160 and regulations 162, collecting needed information, and producing certificate 166, that accurately meets animal movement requirements. Where information stored for an identified animal is already present within database 102 (e.g., within animal records 242 and/or test results 244), information validator 214 determines whether that information is valid for use with certificate 166, wherein certain steps of procedure 164 may be automatically completed by system 100 without requiring additional information. For example, if a certificate has recently been requested for a particular animal, and test results for tests performed on that animal are still valid, information validator 214 may complete one or more steps of procedure 164 using that information, thereby omitting unnecessary tests on the animal and omitting collection of information already available within database 102. In one embodiment, system 100 collects information concurrently from each information source. For example, certificate engine 212 may interact with owner 148, veterinarian 144 and laboratory 138 concurrently to collect required information, initiate tests, and collect test results.

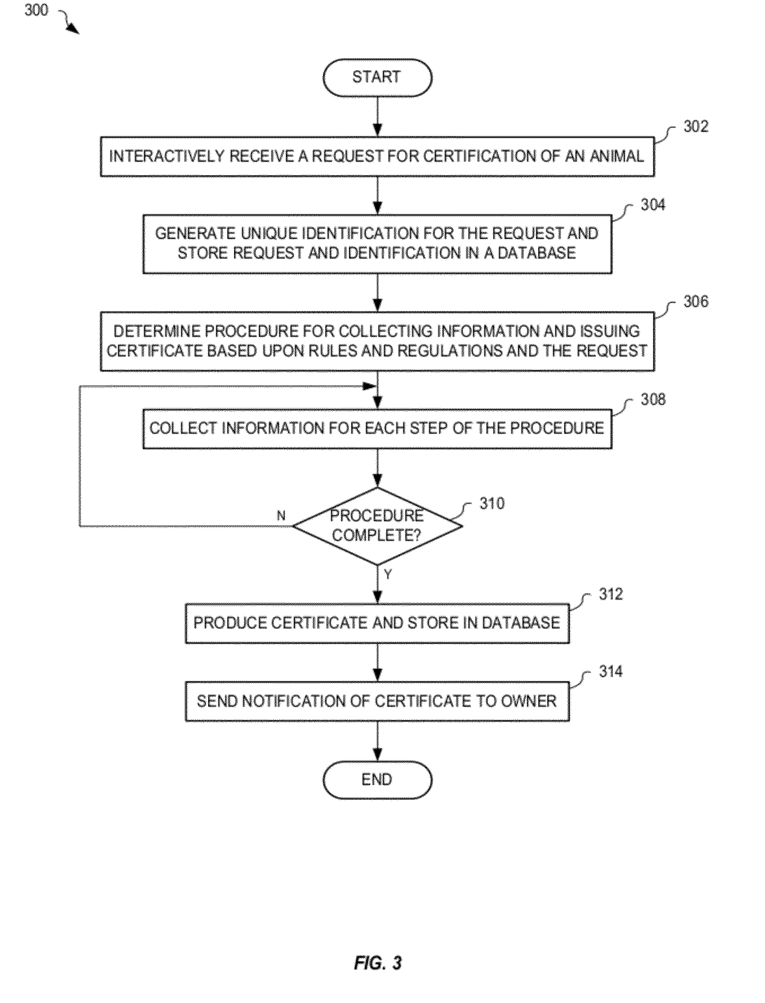

FIG. 3 is a flowchart illustrating one exemplary method 300 for storing and presenting animal certification information. Method 300 is implemented for example as machine executable instructions within software 290 of system 100, as shown in FIG. 2, and in particular within one or more of requirement interpreter 210, certificate engine 212, information validator 214, and certificate producer 216.

In step 302, method 300 interactively receives a request for certification of an animal. In one example of step 302, owner 148 uses browser 150 to interact with system 100, via Internet 120 and web interface 104, to request certification for moving animal 149 (e.g., a horse) from the owner's stable in Iowa to a show arena in Colorado. In another example of step 302, owner 148 interacts with web interface 104 to select animal 149 from animal records 242 of database 102, and then enters desired movement requirements including the starting location and the destination. In another example of step 302, veterinarian 144 selects owner 148 from a list of owners within system 100, selects animal 149 from a list of animal belonging to owner 148, and then enters addresses for the starting location and the destination. In step 304, method 300 generates a unique identification (e.g., a request number), forms a request including the information received in step 302, and stores the request and identification in a database. In one example of step 304, web interface 104 stores, within database 102, the received information within as request 174 in association with a generated unique identifier. System 100 may be integrated with multiple veterinary practice management, laboratory, and other, systems that allow for easy access to data within system 100 and allows requirements to be easily added and/or modified for certification processes.

In step 306, method 300 determines a procedure for collecting information and issuing a certificate based upon the rules and regulations and the request. In one example of step 306, requirement interpreter 210 processes rules 160 and regulations 162 to determine procedure 164 based upon the type of animal identified, the start location, and the destination defined within request 174. For example, procedure 164 includes a plurality of steps for collecting information to fulfill certificate 166, wherein each step defines needed information for at least a portion of certificate 166.

In one embodiment, where an entry permit is required by a destination (and/or transited) state, system 100 collects information (e.g., from one or more of owner 148, veterinarian 144, and laboratory 138) as required by the entry permit. For example, system 100 may include an interactive module that asks questions of owner 148, veterinarian 144, and/or laboratory 138 to verify that conditions have been met for the animal species, purpose of movement, state of origin, and other requirements of the entry permit. Once sufficient information has been collected, system 100 may allow owner 148 to print one or both of the entry permit and an OCVI certificate, while submitting the entry permit and OCVI directly to the states of export and import.

In step 308, method 300 collects information for each step of the procedure. In one example of step 308, certificate engine 212 interacts, via web interface 104, with one or more of owner 148, veterinarian 144, and laboratory 138 to collect animal identification information, movement information, test results, and any other needed information specific to certificate 166.

Step 310 is a decision. If, in step 310, method 300 determines that procedure 164 is complete, method 300 continues with step 312; otherwise method 300 continues with step 308. In one example of step 310, certificate engine 212 invokes information validator 214 to determine whether collected information is sufficient for issuing certificate 166 based upon rules 160, regulations 162 (e.g., vaccination requirements), request 174, animal records 242, and test results 244.

In step 312, method 300 produces a certificate based upon the collected information and stores the certificate in the database. In one example of step 312, certificate producer 216 is invoked to generate certificate 166 that conforms to rules 160 and regulations 162 for the movement of animal 149 based upon request 174, animal records 242, and test results 244. Certificate 166 is stored within database 102 and may include digital signatures that indicate authenticity of the certificate.

In step 314, method 300 sends notification of the certificate to the owner. In one example of step 314, certificate producer 216 sends a notification (e.g., one or more of a text message, an email message, an automated phone call, QR code, barcode, and other electronic means) to one or both of owner 148 and veterinarian 144 that certificate 166 is ready for download from system 100. In another example, certificate producer 216 sends an email 156 containing a digital representation (e.g., in PDF format) of certificate 166 to owner 148. In another example, system 100 notifies one or both of owner 148 and veterinarian 144 when they next login to system 100 using browsers 150 and 146, respectively.

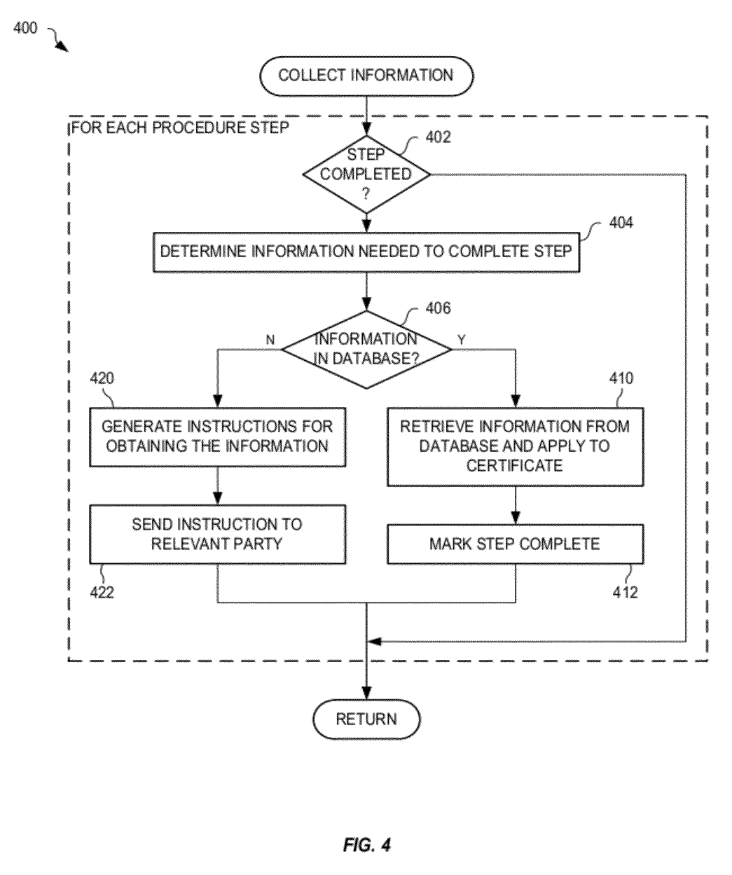

FIG. 4 is a flowchart illustrating one exemplary method 400 for collecting information for step 308 of method 300, FIG. 3. Method 400 is implemented for example as machine executable instructions within certificate engine 212 of system 100. Steps 402 through 442 are repeated for each step of procedure 164. Method 400 may be invoked each time information is received for, and associated with, request 174. That is, method 400 may not run continuously and wait for information to be sent to system 100, rather, method 400 is invoked for a particular request when information associated with that request is received by system 100. In an alternate embodiment, method 400 is invoked periodically to apply information received by system 100 to each appropriate request 174.

Step 402 is a decision. If, in step 402, method 400 determines that the current step is complete, method 400 continues with the next step of procedure 164 at decision 402; otherwise method 400 continues with step 404.

In step 404, method 400 determines the information needed to complete the current step of procedure 164. In one example of step 404, certificate engine 212 determines the information needed for certificate 166 from the current step of procedure 164. Step 406 is a decision. If, in step 406, method 400 determined that the information required for the current step of procedure 164 is within database 102, method 400 continues with step 410; otherwise method 400 continues with step 420.

In step 410, method 400 retrieves information from the database and applies it to the certificate. In one example of step 410, certificate engine 212 searches one or more of request 174, animal records 242, and test results 244 and retrieves information required for the current step of procedure 164 and applied the information to certificate 166. In step 412, method 400 marks the current step of procedure 164 as complete. In one example of step 412, certificate engine 212 sets a flag to indicate that the current step of procedure 164 is completed. Method 400 then continues with step 402 and the next step of procedure 164.

In step 420, method 400 generates instructions for obtaining the information needed for the current step of procedure 164. In one example of step 420, certificate engine 212 asks veterinarian 144 to select a laboratory for testing a blood sample. In another example of step 420, certificate engine 212 generates instructions for veterinarian 144 to collect a blood sample 142 from animal 149, generates a completed laboratory submittal form 143, and instructs the veterinarian to send the sample with submittal form 143 to laboratory 138. In step 422, method 400 sends the instructions of step 420 to the relevant party. In one example of step 422, certificate engine 212 sends the lab submittal form 143 and instructions generated in step 420 to veterinarian 144. Method 400 then continues with step 402 and the next step of procedure 164.

For each step of procedure 164, method 400 requests and/or collects information needed to complete certificate 166. Where information cannot be collected immediately, once the instructions are generated and sent, method 400 proceeds with the next step of procedure 164. When information is received within system 100, method 400 may be invoked to automatically apply the received information to one or more certificates 166. For example, received information includes an identifier that allows method 400 to apply the information to the appropriate request 174 and/or certificate 166. For example, laboratory 138 may enter, or select, the unique request identifier entered automatically by system 100 onto the submitted lab submittal form 143 when entering test results into system 100 using browser 140. For example, system 100 generates a tube number that is unique for each lab submission (see bottom portion of EIA certificate), or identifies a series of test specimen IDs to a group of animals.

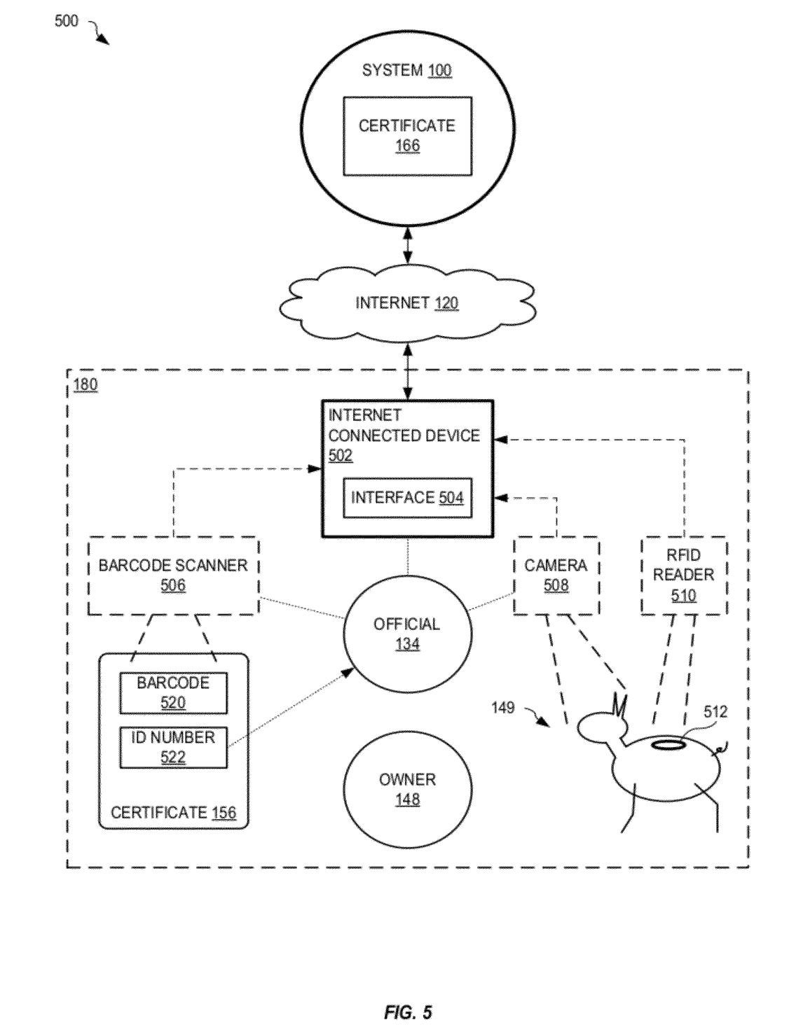

FIG. 5 is a schematic diagram illustrating exemplary use of system 100 to verify authenticity of certificate 166 for an animal passing through a control point 182. Control point 182 is for example at a state border, or an entrance to a stock show. Official 134 verifies that animal 149 being transported by owner 148 has appropriate certification for passing control point 182. In prior systems, official 134 would examine a paper copy of certificate 166 and compare the information entered on the certificate to animal 149, trusting that the signatures of veterinarian 144 and laboratory 138 on the paper copy of certificate 166 indicate the authenticity of the document.

By using system 100, official 134 may authenticate the presented certificate within system 100 and verify that the animal presented at control point 182 is the certified animal. In one example of operation, official 134 interacts with a user interface 504 of an internet connected device 502 to enter an identification number 522 of a presented certificate 166 or scans an electronic image (barcode, QR code, etc.). Device 502 sends the entered ID number 522 to system 100 via Internet 120 and web interface 104. System 100 retrieves certificate 166 using ID number 522 and sends an indication of authenticity and validity of certificate 166 and identifying information of animal 149 back to device 502, where the indication and identifying information is displayed on interface 504. If the indication indicates that certificate 166 is not valid, animal 149 is refused entry. If the indication indicates that certificate 166 is valid, official 134 then compared the identifying features displayed on interface 504 with those of animal 149. If official 134 determines that animal 149 matches the displayed identifying features, the animal is allowed to pass control point 182. If official determines that animal 149 does not match the displayed identifying features, animal 149 is refused entry.

With system 100, certificate 166 need not be printed on paper, but could be displayed on a mobile device of owner 148, for example, since control is based upon a stored copy of certificate 166 within system 100. In one embodiment, a presented copy of certificate 166 includes a barcode 520 representing ID number 522, wherein official 134 utilizes a barcode scanner 506 to read barcode 520 and automatically retrieve an indication of authenticity, validity, and identifying features of animal 149 from system 100.

In another embodiment, a camera 508 captures one or more images of animal 149 and sends these images to system 100 via device 502. System 100 then compares the images with identifying images of animals stored within database 102 to determine the identity of animal 149, and returns an indication of authenticity and validity of an associated certificate 166, together with identifying features of animal 149 for display on interface 504. Thus, system 100 automatically retrieves valid certificates for animals imaged by camera 508.

In another embodiment, an RFID reader 510 reads an ID number from an RFID transponder 512 implanted within animal 149 or affixed to a tag device attached to animal 149 and transfers this ID number to system 100 via device 502, Internet 120, and web interface 104. System 100 then identifies animal 149 and returns an indication of authenticity and validity of an associated certificate 166, together with identifying features of animal 149 for display on interface 504. In this embodiment, system 100 includes a table that associates implanted RFID tag numbers with an identity of the implanted animal, thereby allowing automatic animal identification and verification of associated certificates.

In one embodiment, device 502 includes one or more of scanner 506, camera 508, and RFID reader 510. For example, camera 508 may be used to scan an animal's iris or retina to identify and/or record an identity for the animal. Device 502 may include other analyzers, such as a DNA test profiler, for identifying a particular animal. Device 502 is for example a smart phone that includes a camera, has connectivity to Internet 120, and executes an application that interfaces with web interface 104 of system 100, wherein the smart phone application captures images of barcode 520, ID number 522, and/or animal 149 for processing within system 100 to determine certificate 166. Device 502 may be implemented with other types of camera and/or electronic instrument for identifying animals and cooperating with system 100 without departing from the scope hereof.

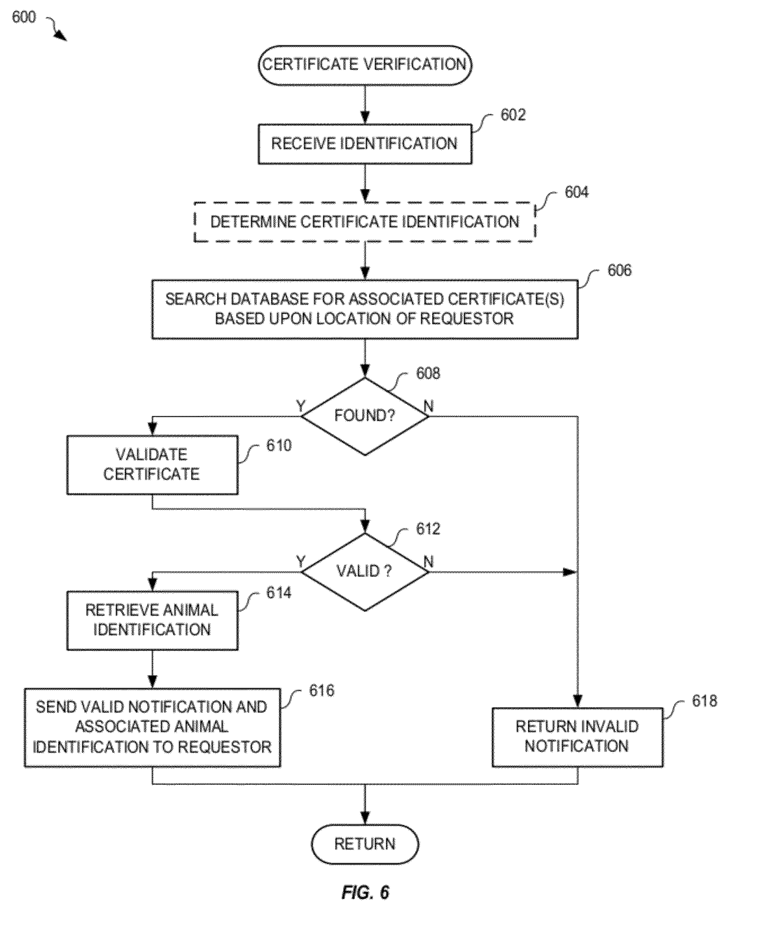

FIG. 6 is a flowchart illustrating one exemplary method 600 for validating an identified certificate within system 100. Method 600 is implemented for example within certificate validator 218 and allows officials (e.g., state official 134, and other parties) to validate certificates presented for animals (e.g., animals being moved, sold, slaughtered, and so on). In step 602, method 600 receives identification for retrieving a certificate. In one example of step 602, certificate validator 218 receives, via Internet 120 and web interface 104, an identification scanned from barcode 520 of the presented copy of certificate 166 by device 502 using scanner 506. In another example of step 602, certificate validator 218 receives, via Internet 120 and web interface 104, an RFID tag number of animal 149 scanned by device 502 using RFID reader 510. Device 502 may provide other information to certificate validator 218 such as one or more of an iris or retina scan, a DNA test profile, a QR code scan, a barcode scan, and so on. Step 604 is optional. If the identification received in step 602 is for a certificate (e.g., ID number 522 of certificate 166), step 604 is omitted; if the identification received in step 602 is for an animal, in step 604, method 400 determines at least one associated certificate identifier for the identified animal by searching the database. In one example of step 604, certificate validator 218 searches database 102 to determine identification of certificate 166 associated with animal 149 identified by the identification received in step 602. At remote access sites, such as trail rides, shows, auctions, and other such events, device 502 is implemented as a portable device with wireless access to system 100 via Internet 120, for example.

In step 606, method 600 searches the database for at least one certificate having the received identification of step 602 or the determined identification of step 604. In one example of step 606, certificate validator 218 searches database 102 to retrieve information of certificate 166 identified by ID number 522 received in step 602. In another example of step 606, certificate validator 218 searches database 102 to retrieve information of certificate 166 identified in association with animal 149 in step 604.

Step 608 is a decision. If, in step 608, method 600 determines that the certificate was found in the database, method 600 continues with step 610; otherwise method 600 continues with step 618.

In step 610, method 600 validates the retrieved certificate. In one example of step 610, certificate validator 218 invokes information validator 214 to re-validate information of certificate 166, wherein information validator 214 verifies that the certificate is still valid (i.e., has not expired or been withdrawn).

Step 612 is a decision. If, in step 612, method 600 determines that the identified certificate is valid, method 600 continues with step 614; otherwise, method 600 continues with step 618.

In step 614, method 600 retrieves animal identification information associated with the certificate. In one example of step 614, certificate validator 218 retrieves identification information for animal 149 from animal records 242, where animal 149 is associated with the retrieved information of step 606. In step 616, method 600 sends a valid notification and associated and identification to the requestor. In one example of step 616, certificate validator 218 sends a positive indication that the identified certificate is valid, and also sends identification information of the associated animal to allow the requestor to verify that the presented certificate is for the presented animal. Method 600 then terminates. For example, the identification information, optionally including images of the animal, is displayed on interface 504 of device 502 allowing official 134 to verify that animal 149 matches the information on certificate 166.

In step 618, method 600 sends an invalid notification to the requestor. In one example of step 618, certificate validator 218 sends a negative indication to device 502, wherein device 502 indicates (e.g., using interface 504 to make and noise and of display a negative indication) to official 134 that the presented certificate is not valid.

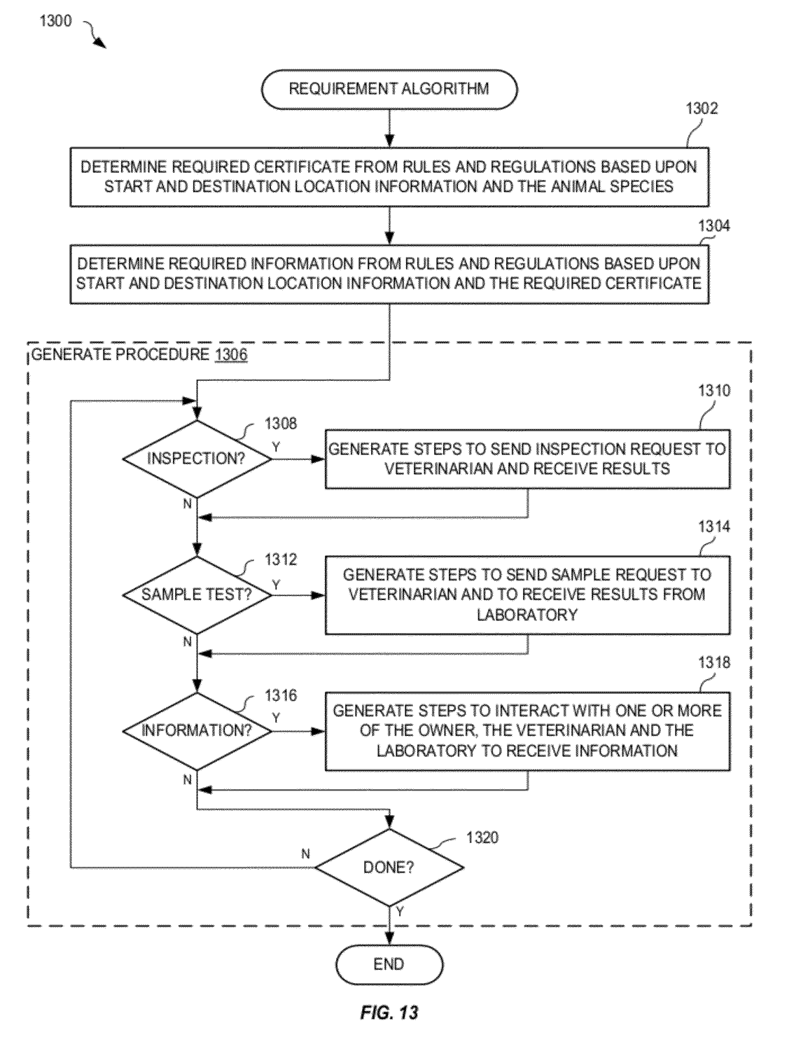

FIG. 13 shows one exemplary method 1300 for generating procedure 164 for collecting required information for certificate 166 of FIGS. 1 and 2. Method 1300 is implemented within the algorithm of requirement interpreter 210 of system 100, for example. Method 1300 generates procedure 164 by automatically determining, from rules 160, certificates required for request 174. For example, where request 174 is a request for a certificate to move animal 149 from a first state to a second state, rules 160 and regulations 162 for each of the first and second states define the required certificates 166 and information to complete the certificates.

In step 1302, method 1300 determines the required certificate from rules and regulations based upon start and end location information and the animal species. In one example of step 1302, requirement interpreter 210 searches rules 160 and regulations 162 to determine certificate requirements associated with movement of animal 149 between the first and second locations. In one embodiment, rules 160 and regulations 162 are entered (e.g., by state veterinarian 130) in a format that defines certification requirements for each of the first and second locations based upon the type of animal 149. In step 1304, method 1300 determines required information from rules and regulations based upon start and destination location information and the required certificate. In one example of step 1304, requirement interpreter 210 searches rules 160 and regulations 162 to determine required information for certificate 166 based upon the type of certificate, and the start and end locations. For example, based upon the end location, rules 160 and regulation 162 are searched to determine whether veterinary inspections and blood sample tests are required and determines other information (e.g., details of owner 148, veterinarian 144, laboratory 138, and animal 149) required to complete certificate 166.

Steps 1308 through 1320 repeat for each data item and/or action to generate procedure 166, and indicated by dashed box 1306. Each added step and/or procedure 164 is associated with certificate 166. Step 1308 is a decision. If, in step 1308, method 1300 determines that the next data item requires inspection of the animal by an accredited veterinarian, method continues with step 1310; otherwise method 1300 continues with step 1312. In step 1310, method 1300 generates steps to send an inspection request to an accredited veterinarian and to receive results of the inspection from the veterinarian. In one example of step 1310, requirement interpreter 210 adds a step of “send an inspection request of animal 149 to veterinary 144” to procedure 164, and then adds a step of “receive inspection results from veterinary 144” to procedure 164.

Step 1312 is a decision. If, in step 1312, method 1300 determines that the next data item requires that a sample be tested, method 1300 continues with step 1314; otherwise method continues with step 1316. In step 1314, method 1300 generates steps to send a sample request to an accredited veterinary and to receive results from an accredited laboratory. In one example of step 1314, requirement interpreter 210 adds a step of “send sample request to veterinarian 144” and adds a step of “receive test results from laboratory 138” to procedure 164.

Step 1316 is a decision. If, in step 1312, method 1300 determines that the next data item requires additional information, then method 1300 continues with step 1318; otherwise method 1300 continues with step 1320. In step 1318, method 1300 generates steps to interact with one or more of the owner, the veterinarian, and the laboratory to receive the additional information. In one example of step 1318, requirement interpreter 210 adds a step of “interact with owner 148 to receive home address of the owner” to procedure 164. In another example of step 1318, requirement interpreter 210 adds a step of “interact with veterinarian 144 to receive digital signature of the veterinarian” to procedure 164.

Step 1320 is a decision. If, in step 1320, method 1300 determines that steps have been generated for all data items, method 1300 terminates; otherwise method 1300 continues with step 1308.

Rules 160 and regulations 162 may be configured to facilitate searching by method 1300 of FIG. 13, and are maintained by authorized officials (e.g., state veterinarian 130, state official 190) that update rules 160 and regulations 162, wherein certificate 166 is generated to confirm to these latest rules and regulations.

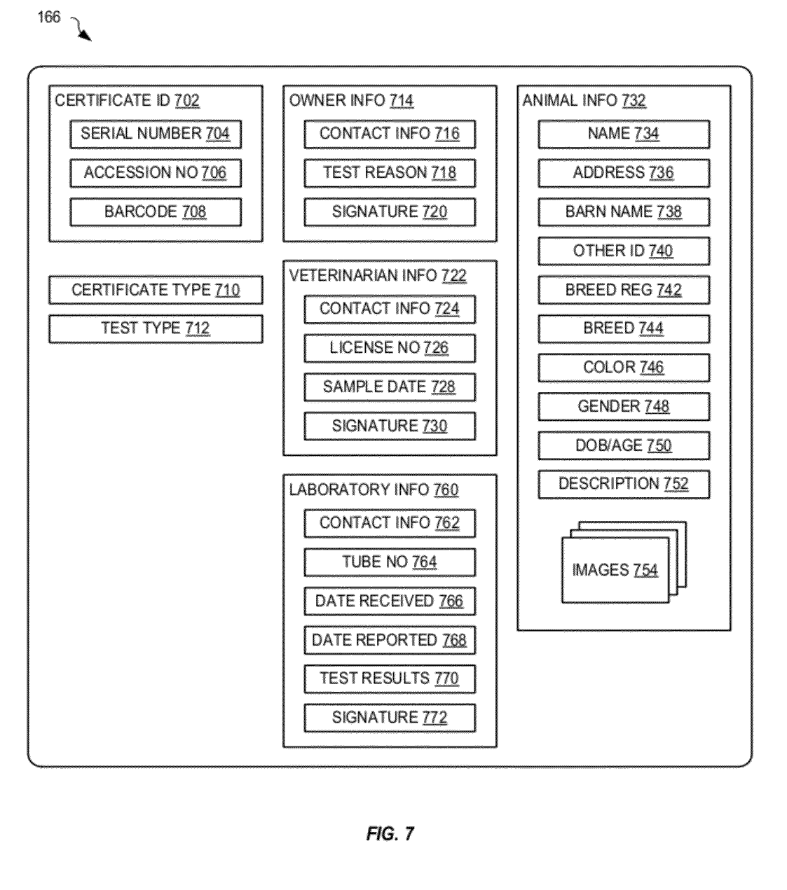

FIG. 7 is a schematic showing exemplary detail of certificate 166. Certificate 166 has a certificate identifier 702 that uniquely identifies certificate 166, owner information 714 that provides contact information of the animal owner (e.g., owner 148), veterinarian information 722 the provides information of the certified veterinarian (e.g., veterinarian 144) collecting a sample (e.g., sample 142) from the animal, animal information 732 that provides information of the animal (e.g., animal 149) being certified, and laboratory information 760 that provides information of the laboratory performing test on the sample.

Certificate identifier 702 includes a serial number 704 associated with the type of certificate 166, an accession number 706 that is unique, and optionally a bar code 708 (or QR code or other machine readable format) that is also unique and may represent accession number 706. Certificate identifier 702 is for example stored within database 102 in association with one or more of: animal records 242 (i.e., animal 149), owner 148, and veterinarian 144. A certificate type 710 defines the type (e.g., OCVI, Online EIA, and eVRx®) of certificate 166, and a test type 712 defines the type of test to be performed on the sample taken from the animal. For example, EIA/Coggins certificates require an EIA test; OCVI certificates may require one or more tests, whereas tracking of veterinary applied medications may not require a test at all.

Owner information 714 includes contact information 716 (e.g., name, address and telephone numbers), test reason 718 (e.g., a reason for the test, such as annual, movement, and so on), and a signature 720 (e.g., a digital signature) of the owner indicating that the owner believes that owner information 714 and animal information 732 is correct.

Veterinarian information 722 includes contact information 724 (e.g., name, address and telephone numbers), a license number 726 (e.g., a federal accreditation number or a veterinary license number), a sample date 728 indicating a date when a sample (e.g., sample 142) was taken from the animal (e.g., animal 149), and a signature 730 (e.g., a digital signature from digital signatures 246) indicating that the veterinarian (e.g., veterinarian 144) believes entered information of animal information 732 and veterinarian information 722 is correct.

Animal information 732 describes the certified animal and includes a name 734 (e.g., a registered name of the animal), an address 736 (e.g., a stable address), a barn name 738 (e.g., a nickname of the animal), other identifying names or numbers 740, breed registration 742 (e.g., a number identifying the breed of the animal), a breed 744 (e.g., the commonly used name of the breed), a color 746 (e.g., coat color of the animal), a gender 748 (e.g., one of male, female, gelding, and neuter), date of birth or age 750 (e.g., the date the animal was birthed), description 752 (e.g., a narrative description of the animal's distinguishing features, such as color, markings, brand(s), and so on), and images 754 (e.g., images taken of the animal). Animal information 732 may also include iris or retina scan data, DNA test profile data, QR code data, barcode data, and other such data for identifying the animal.

Laboratory information 760 includes contact information 762 (e.g., name, address and telephone numbers), one or more tube numbers 764 (e.g., a uniquely identifying number identifying a sample within the laboratory), date received 766, date reported 768 (e.g., the date the test results are reported), test results 770 (e.g., positive or negative), and a signature 772 (e.g., a digital signature indicating that the test results are entered by a certified laboratory technician).

Certain information of certificate 166 may change for different animals and different tests without departing from the scope hereof.

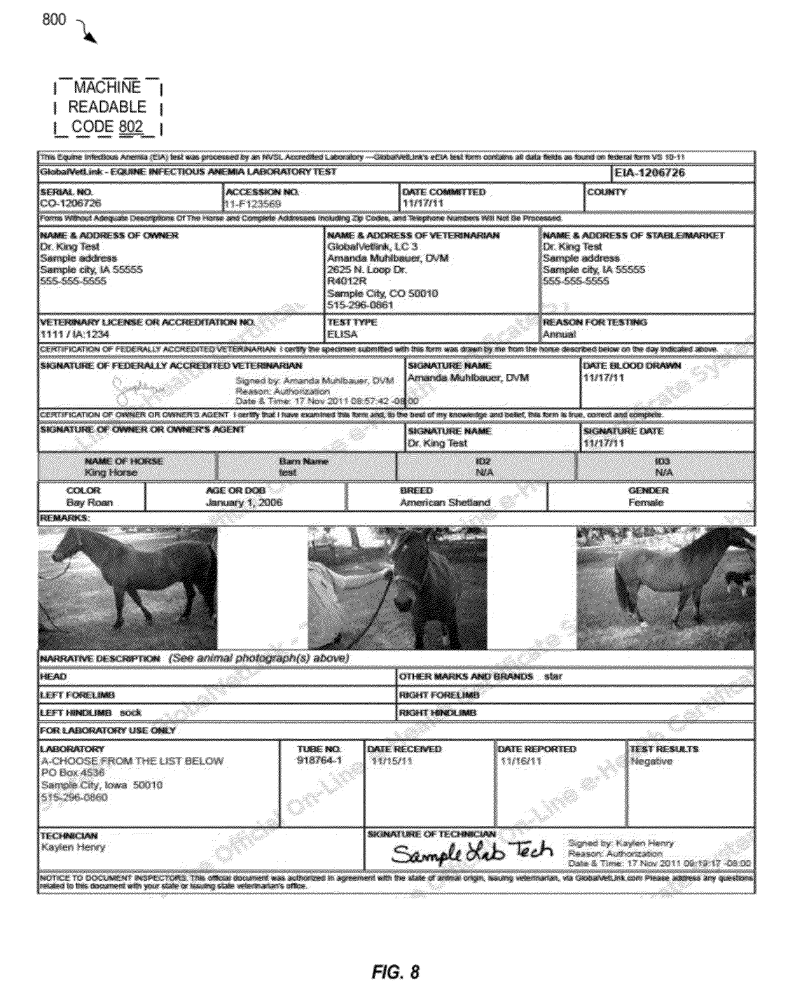

FIG. 8 is an image 800 of one exemplary certificate 166 produced by system 100 of FIG. 1 and printed by owner 148 using printer 152 for example. Optionally, image 800 may include a machine readable code 802 (e.g., a barcode or a, QR code) to facilitate verification of certificate 166 at a control location, where machine readable code 802 is scanned to determine certificate ID number 522 of certificate 166 for verification within system 100.

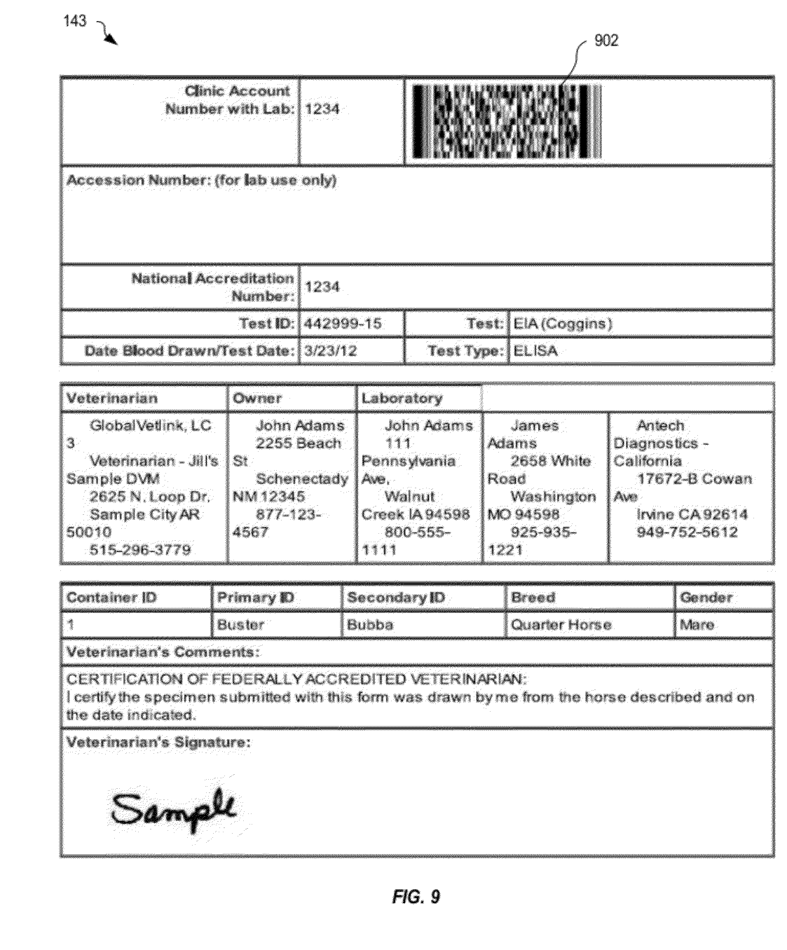

FIG. 9 shows one exemplary laboratory submittal form 143 with a machine readable code 902 that facilitates tracking of blood sample 142, sent by veterinarian 144 to laboratory 138, within system 100 of FIGS. 1 and 2.

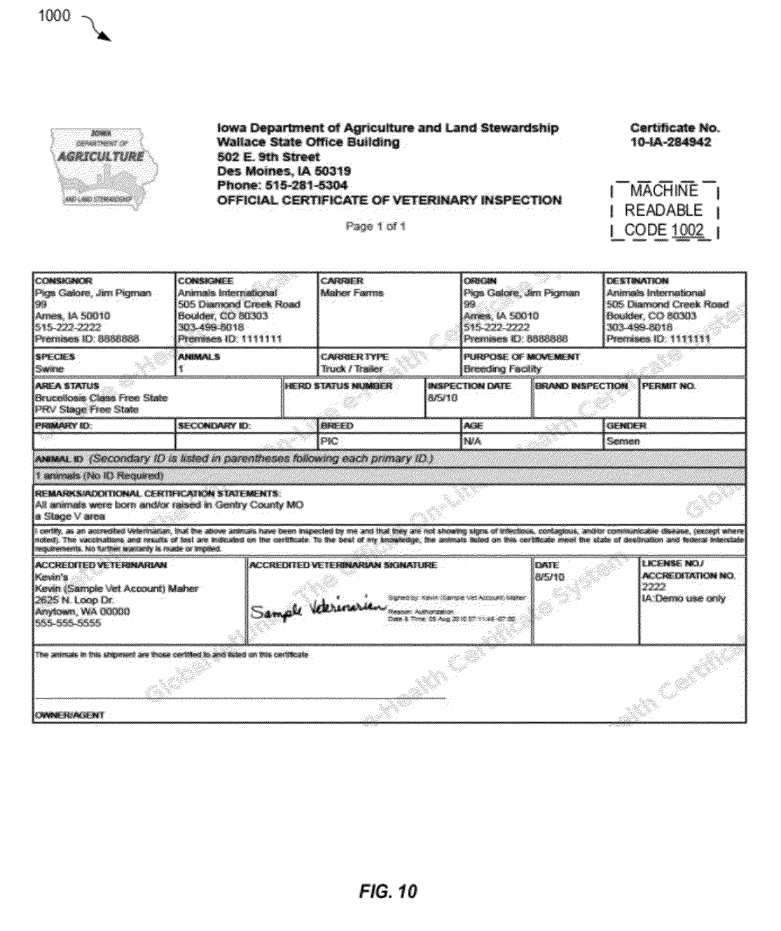

FIG. 10 shows one exemplary veterinary inspection certificate 1000 that is generated by system 100 of FIGS. 1 and 2 to indicate inspection of animal 149 by certified veterinarian 144. Certificate 1000 may include a machine readable code 1002 (e.g., a barcode or a, QR code) that facilitates automatic validation of certificate 1000 within system 100. For example, an official may use a device to scan machine readable code 1002 to determine a certificate ID of certificate 1000, send the certificate ID to system 100 (e.g., via Internet 120) and receive, substantially in real time, an indication of the validity of certificate 1000.

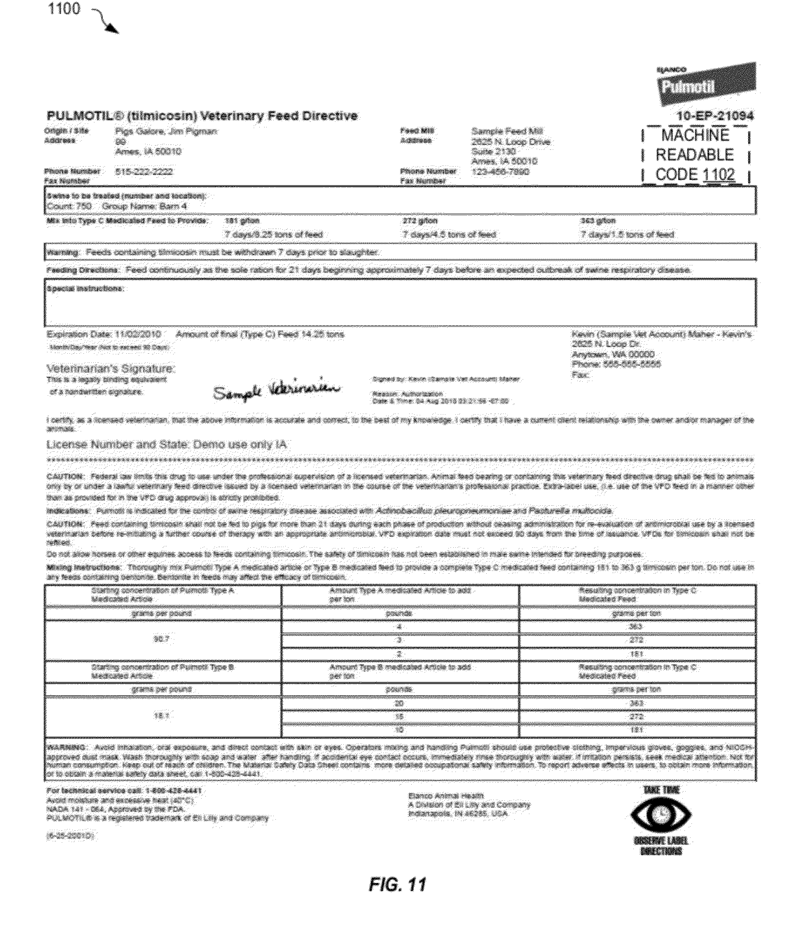

FIG. 11 shows one exemplary prescription certificate 1100 for use of medication within animal feed, as tracked by system 100 of FIGS. 1 and 2. Certificate 1100 may include a machine readable code 1102 (e.g., a barcode or a, QR code) that facilitates automatic validation of certificate 1100 within system 100.

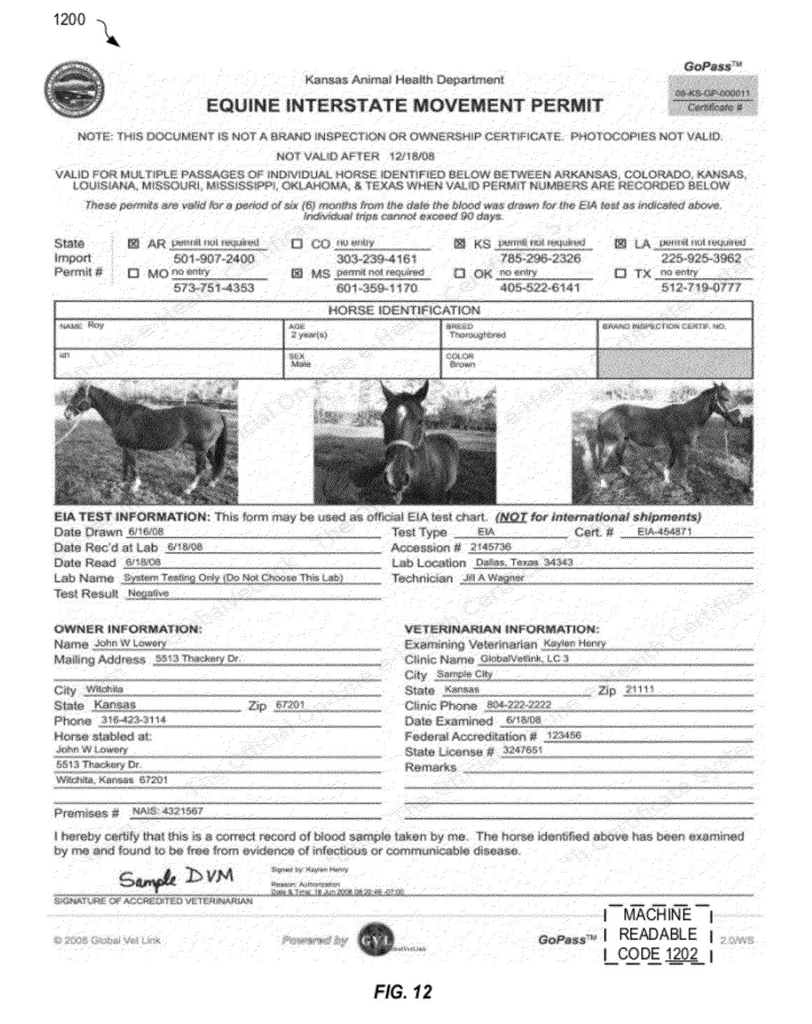

FIG. 12 shows one exemplary certificate 1200 generated by system 100 of FIGS. 1 and 2 as required to move a horse (e.g., animal 149) between states. Certificate 1200 may include a machine readable code 1202 (e.g., a barcode or a, QR code) to determine a certificate ID of certificate 1200, send the certificate ID to system 100 (e.g., via Internet 120) and receive, substantially in real time, an indication of the validity of certificate 1200. For example, an official at a state border may use a mobile device to scan code 1202, send a determined certificate ID to system 100, and receive, substantially in real-time, an indicate of validity of certificate 1200.

In one embodiment, system 100 may be used to perform additional checks wherein both the certificate ID number 522 and/or barcode information are verified against the RFID tag ID read from animal 149. System 100 may use other information (e.g., iris or retina scan, DNA test profile, and other types of tag or code) to validate the animals identity and validity of certificate 166.

In another embodiment, where presented animals each have an implanted or externally attached RFID tag, system 100 may cooperate with device 502 to automatically identify each presented animal and verify that the animal has a valid certificate.

In another embodiment, system 100 and device 502 cooperate to capture images (e.g., using camera 508 attached to, or incorporated within device 502) of presented animals, identify each presented animal based upon the captured images, and verify that each animal has an associated and valid certificate.

Changes may be made in the above methods, and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented system for animal certification, comprising:
a database for storing rules and regulations that define requirements for the animal certification;
a web interface for receiving a request for a certificate for an animal;
a requirement interpreter for generating a procedure for acquiring information required to complete the certificate based upon the rules and regulations and a type of the certificate;
a certificate engine for collecting information for the certificate based upon the procedure; and
a certificate producer for generating the certificate based upon the collected information and for storing the certificate within the database.

2. The computer-implemented system of claim 1, wherein the web interface is configured to interact with each of: a certified veterinarian, an owner of the animal, and a laboratory that tests samples taken from the animal.

3. The computer-implemented system of claim 2, wherein the web interface is configured to interact with an official to maintain the rules and regulations.

4. The computer-implemented system of claim 1, wherein the rules and regulations define requirements for certification of animals within each of one or more states within the United States of America.

5. The computer-implemented system of claim 1, further comprising an information validator for validating the collected information against the rules and regulations to determine whether the collected information is sufficient to complete the certificate and is valid.

6. The computer-implemented system of claim 1, wherein the type of certificate is selected from the group including: Official Certificates of Veterinary Inspection (OCVI), Online EIA (Coggins Certificates), Electronic Veterinary Prescription Certificate System (eVRx®), For Sale Certificate (Pre-Purchase Exam), Pre-Conditioning Certificate, Vaccination Certificates, Insurance or Related Exam Certificate, and Lab Test Certificate.

7. The computer-implemented system of claim 1, wherein the certificate engine interacts, via the Internet, with one or more of: an owner of the animal, a veterinarian, and a laboratory, to collect the information.

8. The computer-implemented system of claim 7, wherein the certificate engine generates, based upon the procedure, a request for an action to be completed by one or more of: the owner, the veterinarian, and the laboratory.

9. The computer-implemented system of claim 7, wherein the certificate engine receives, and stores in the database in association with the certificate, digital signatures from one or more of the owner, the veterinarian, and the laboratory to certify that supplied information is correct.

10. The computer-implemented system of claim 1, further comprising a certificate validator for responding to a request from a third party to validate the certificate, wherein the certificate validator retrieves information of the certificate from the database and responds to the third part indicating whether the certificate is valid based upon the rules and regulations.

11. The computer-implemented system of claim 10, wherein the request includes a unique certificate identifier that identifies the certificate stored within the database.

12. The computer-implemented system of claim 11, wherein the certificate identifier is automatically read by a device used by the third party from a visible copy of the certificate presented to the third party.

13. The computer-implemented system of claim 10, wherein the request includes an identifier of the animal and wherein the certificate validator retrieves information of the certificate from the database based upon the identifier.

14. The computer-implemented system of claim 10, wherein the certificate validator sends identification information of the animal associated with the certificate to the third party.

15. A computer implemented method for issuing a certificate for an animal, comprising the steps of:
receiving a request to generate the certificate;
determining required information for the certificate based upon rules and regulations, stored within a database, that define information requirements for the certificate;
interacting with one or more of an owner of the animal, a certified veterinarian, and a laboratory to collect the required information;
generating the certificate, when the required information is complete, with a unique certificate identifier; and
storing the certificate within the database.

16. The method of claim 15, further comprising:
receiving regulating information defining the required information from an official; and
updating the rules and regulations within the database based upon the regulating information.

17. The method of claim 15, further comprising sending the certificate to one or more of the owner, the certified veterinarian, and an official.

18. The method of claim 15, further comprising responding to a request the unique certificate identifier received from a third party by retrieving information of the certificate from the database and sending a response to the third party indicating whether the information is valid based upon the rules and regulations.

19. The method of claim 18, wherein the response includes identification information of the animal stored within the database in association with the certificate.

20. The method of claim 15, wherein the certificate is required for movement of the animal between a first and second location, wherein the rules and regulations define the required information for at least the second location.

21. The method of claim 20, wherein the first and second locations are in a different state within the United States of America and wherein the rules and regulations are defined for each state.

22. A device for determining validity of a certificate for an animal, comprising:
a network interface for communicating with a certification system;
a user interface for interacting with a user of the device; and
an application running on the device, the application having machine readable instructions that when executed by a processor of the device perform the steps of:
determining identification information associated with the certificate;
sending the identification information to the certification system;
receiving, from the certification system, an indication of validity of the certificate; and
displaying the indication on the user interface.

23. The device of claim 22, further comprising a reader for optically reading the identification information from a presented copy of the certificate.

24. The device of claim 23, wherein the reader determines the identification information from one of a barcode and a QR code.

25. The device of claim 22, further comprising an RFID reader for reading the identification information from an RFID tag associated with the animal.

26. The device of claim 22, further comprising a camera for capturing an image of the animal, wherein the image is sent to the certification system to identify the certificate.

27. The device of claim 26, the image comprising one of an iris image and a retina image.

28. A computer-implemented system for animal certification, comprising:
a database for storing rules and regulations that define requirements for the animal certification;
a web interface for receiving a request for a certificate for an animal;
a certificate engine for collecting information required to complete the certificate based upon the rules and regulations and a type of the certificate;
an information validator for validating the collected information against the rules and regulations to determine whether the collected information is sufficient to complete the certificate and is valid; and
a certificate producer for generating the certificate based upon the collected information and for storing the certificate within the database.

29. The computer-implemented system of claim 28, further comprising a certificate validator for responding to a request from a third party to validate the certificate, wherein the certificate validator retrieves information of the certificate from the database and responds to the third part indicating whether the certificate is valid based upon the rules and regulations.
